(19) United States
(12) Patent Application Publication
(10) Pub. No.: US 2014/0179261 A1
(43) Pub. Date: Jun. 26, 2014

(54) SYSTEM AND METHOD FOR MONITORING AND RESTRICTING THE USAGE OF A MOBILE COMMUNICATION DEVICE

(71) Applicant: Anzen Electronics, LLC, Carmel, IN (US)

(72) Inventors: Steven J. Riggs, West Lafayette, IN (US); Richard J. Skertic, Carmel, IN (US)

(73) Assignee: Anzen Electronics, LLC, Carmel, IN (US)

(21) Appl. No.: 14/190,689

(22) Filed: Feb. 26, 2014

Related U.S. Application Data
(63) Continuation-in-part of application No. 12/868,213, filed on Aug. 25, 2010, now Pat. No. 8,676,268.

(51) Int. Cl. H04W 4/02; H04W 76/00

(52) U.S. Cl. CPC H04W 4/02; H04W 76/007
USPC 455/404.2; 455/456.1

(57) ABSTRACT

A method is provided wherein a location, for example a GPS location, of the mobile communication device (100) is determined, and a location, for example a GPS location, of the vehicle is determined. The location of the mobile communication device (100) is compared to the location of the vehicle. A location of the mobile communication device (100) is triangulated within the vehicle based on the comparison of the location of the mobile communication device (100) to the location of the vehicle. The use of the mobile communication device (100) is controlled based on the location of the mobile communication device (100) within the vehicle.

### CROSS-REFERENCE TO RELATED APPLICATIONS

This application is continuation in part of and claims the benefit of U.S. patent application Ser. No. 12/868,213, filed Aug. 25, 2010 and titled “SYSTEM AND METHOD FOR MONITORING AND RESTRICTING THE USAGE OF A MOBILE COMMUNICATION DEVICE”, which is hereby incorporated by reference.

### BACKGROUND OF THE INVENTION

The premise of the idea is to inhibit mobile communications from executing while driving only, and not block the use of the mobile communication device being used by others within the vehicle or when not moving or not in the vehicle. There are two context levels to this product. The first level is to disable the mobile communications device while the vehicle is moving. The second level is to determine if the mobile communications device is in the vicinity of the driver and if so, keep that mobile communications device disabled and reestablish communications for all other mobile communications devices unless they too are in the vicinity of the driver. The mobile communications device should function as normal when it is not moving or is not in a vehicle.

### BRIEF SUMMARY OF THE INVENTION

This invention relates to a methodology, algorithms and monitoring controls for the use of a mobile communications device within a vehicle to prevent the driver from becoming distracted while driving (DWD) but allow the usage of the mobile communications device when not driving (a passenger) or when not in a moving vehicle or during an emergency. A DWD driver has become a serious problem in today's society. “Driver inattention is a factor in more than 1 million crashes in North America annually, resulting in serious injuries, deaths and an economic impact reaching nearly $40 billion per year”; as reported by the AAA Foundation for Traffic Safety.

There are a few methods in the prior art that address this concern but go to great lengths in defining an approach that redefines the current mobile network to accommodate their methodology. There seems to still be a need for a simpler less intrusive method or approach.

The current methodology presented here will offer significant advantages over prior devices and methods by providing, according to one embodiment of the invention, a method of determining the real time location of the mobile communication device within a moving vehicle to limit driver distraction. The invention does not determine the level of risk associated with having the functions available. This is assumed to be factual that DWD drivers are at high risk. The determination of the mobile communication device' location is achieved through another embodiment of the invention that gathers the mobile communication device environmental/geometrical context information as well as vehicle environmental/geometrical context information to be evaluated by assessment algorithms to determine if the mobile communication device should have full access to all of its functions. Passengers can call, text and run application functions but when the phone is moved into the vicinity of the driver the call, text messaging and application functions are disabled.

The mobile communication device will assess its own context information, according to one embodiment of the invention, to determine how to manage its own functions. According to a further embodiment of the invention, it is only through the initiation of a synchronization methodology between the mobile communication device and the vehicle that will determine if the mobile communication device will continue functioning in the mobile communication devices previous, on going or determined communications state.

The real time location of the mobile communication device within a moving vehicle is further enhanced, according to one embodiment of the invention, through a periodic synchronization signal algorithm methodology allowing the vehicle to determine where the mobile communication device is located at any one time and allowing the mobile communication device to continue functioning in its current state. If the vehicle does not have a GPS then all phones in the vehicle will be disabled because they will be moving.

Neither the foregoing summary nor the following description purports to define the invention. The invention is defined by the claims.

### BRIEF DESCRIPTION OF THE DRAWINGS

FIG. 1 illustrates aspects of the mobile communication device in an embodiment of mobile communication device environment.

FIG. 2 illustrates aspects of the vehicle communication device in an embodiment of vehicle computational context environment

FIG. 3A-3B illustrates the computational flow diagram algorithm of the mobile communication device utilizing the mobile communication device environmental/geometrical context to inhibit all communications.

FIG. 4 illustrates the computational flow diagram algorithm for the vehicle utilizing the mobile communication device environmental/geometrical context along with the vehicle context to decide if the mobile communication device should be allowed to function normally once synchronized with the vehicle.

### DETAILED DESCRIPTION OF THE PREFERRED EMBODIMENTS/INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

A preferred embodiment of the present invention provides for the monitoring and restricting the use of a mobile communication device given the determination of the current mobile communication device environment/geometrical context and a level of risk associated with the use of the mobile communication device within that geometrical context definition.

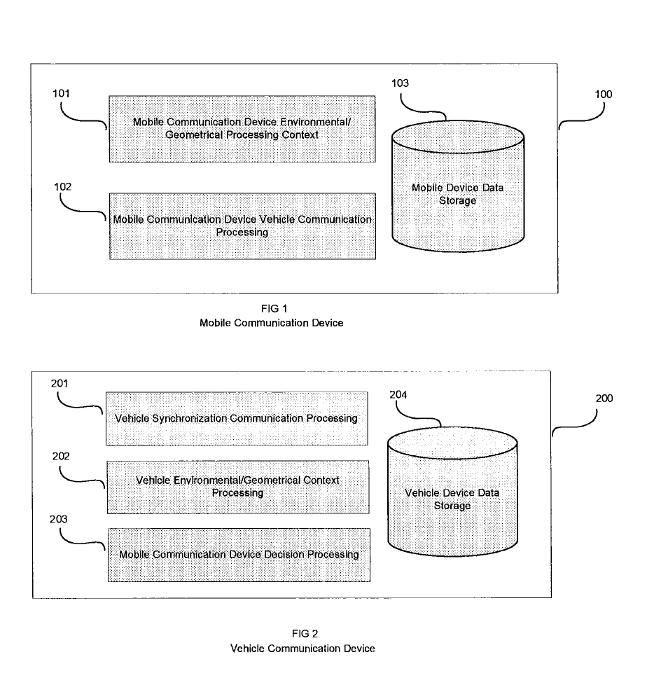

The system and method generally comprised of the mobile communication device (100), its sensors and the vehicle computational device (200) with its sensors which can be a separate component in the vehicle or a vehicle controller. The mobile communication device of FIG. 1 can include components to facilitate one or more functions required by this invention but does not define the total functional capability of the mobile communications device (100) and is used here for illustrative purposes only. The mobile communication device (100) includes algorithms to process the mobile communication device environmental/geometrical context (101), a mobile communication device vehicle communication processing (102) and a mobile communication device data storage (103).

The mobile communication device (100) includes the environmental/geometrical context processing algorithm (101) to determine the mobile communication device information context. This mobile communication device context information is used to determine the mobile communication device mobility and if such velocity which is defined with a directional vector, has reached a minimum value. This context information and the decision shall be exercised before, during or after any communication channel had been established and at a periodic interval. Once the criterion has been met, the communication channel is inhibited from being utilized. This inhibit state will continue until the mobile communication device context information does not satisfy the decision criterion or an emergency communication channel has been initiated.

The mobile communication device (100) can further include a mobile communication device data storage (103) for recording the past mobile communication device context information as well as the current context information and the various context/decision algorithms or processes used by the mobile communications device to assess in determining if the minimum velocity has been achieved. It further stores that decision point value as well as the algorithms to inhibit the communication channel and all application functions.

The mobile communication device (100) further includes the mobile communication device vehicle communication synchronization algorithms and processing (102). This process shall be initiated by the user if desired so that the vehicle communication device can determine the risk level involved for using the mobile communication device. This vehicle communication channel must synchronize in order for the mobile communication device to transmit its information context to the vehicle for processing. The vehicle processing algorithms shall be defined in greater detail below.

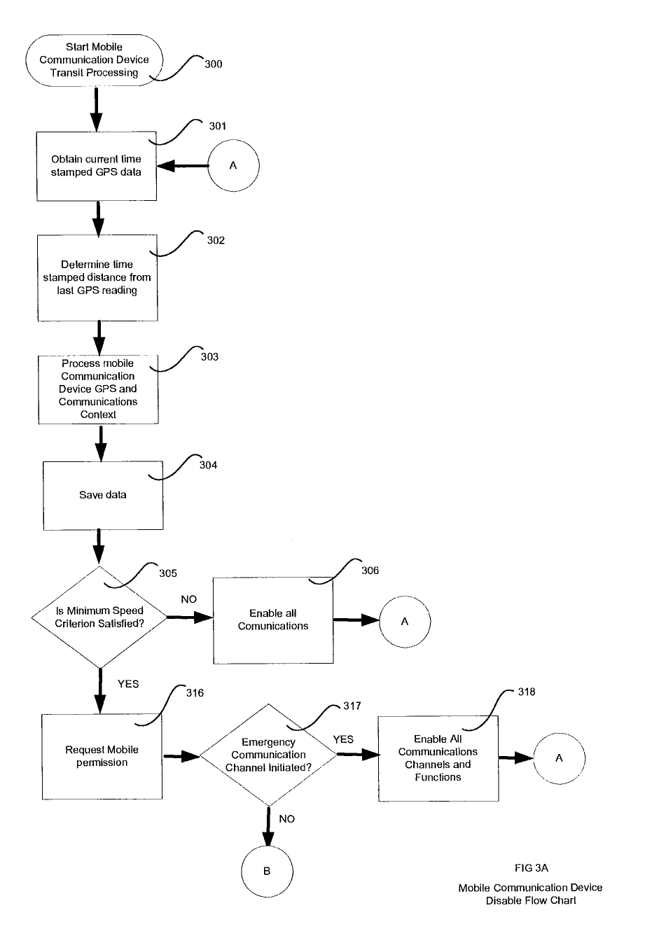

The vehicle communication device of FIG. 2 can include components to facilitate one or more functions required by this invention but does not define the total functional capability of the vehicle communications device (200) and is used here for illustrative purposes only. The vehicle communication device (200) includes algorithms to process the vehicle communication device environmental/geometrical context (202), a vehicle communication device processing (201), mobile communication device decision algorithm processing (203) and a vehicle device data storage (204).

The vehicle communication device (200) includes the environmental/geometrical context processing algorithm (202) to determine the vehicle device information context. This vehicle device context information is used to determine the geometrical context of the mobile communication device and if the context is determined not to be within a defined area within the vehicle by executing the Mobile communication device decision algorithm processing (203), an unrestrained command is sent to the mobile communication device across the synchronized communication channel (201) to allow normal mobile communication device functionality. This geometrical context information and the determination of whether the mobile communication device is within the defined area shall be exercised before, during or after any communication channel had been established and at a periodic interval.

The vehicle communication device (200) can further include a vehicle device data storage (204) for recording the past vehicle device context information as well as the current context information and the various context/decision algorithms or processes used by the vehicle communication device (200) to assess if the mobile communication device enters or is in a define area of the vehicle. It further stores the area definition as well as the algorithms to sustain the synchronization communication channel and if the mobile communication device is to be inhibited or not.

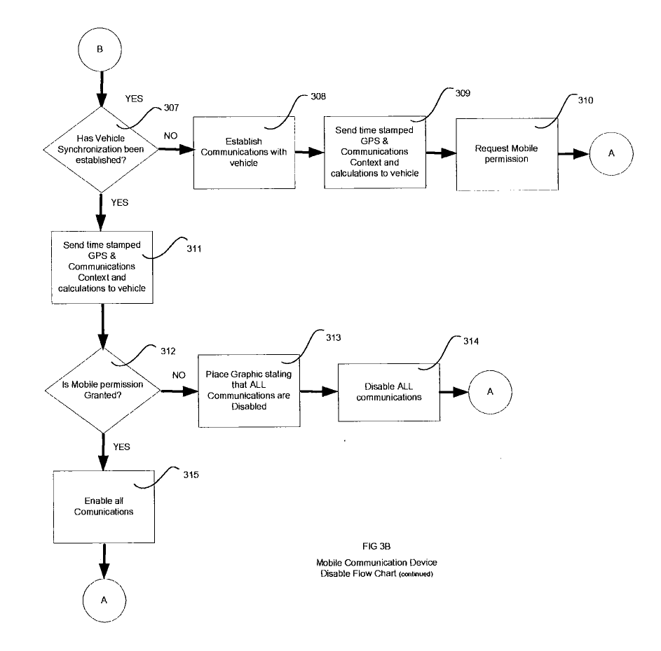

The context algorithms use by the mobile communication device algorithms processing (101) is illustrative in a process flow diagrams in FIG. 3A-3B. As stated above, the mobile communication device processing routine (300) acquires environmental/geometrical context information (301) from the mobile communication device' (100) integrated sensors to determine the velocity of the device. For example, the algorithm can be used to analysis time stamped Global Positioning System or GPS context data in conjunction with the mobile storage device context data (103) to calculate appropriate context data (303) to determine distance and movement. The resulting context data is stored (304). This context data is further analyzed (305) to determine if a minimum velocity criteria has been achieved. If the criteria has not been achieved than the mobile communication device (100) remains in the normal functioning state (306). If the criteria is achieved, than all mobile communication channels and functions (316) are disabled.

The process also includes processing for establishing a user initiated vehicle synchronization command (307). If the command is issued than the mobile communication device (100) tries to establish a communication channel with the vehicle (308). Once established, the context that is in the mobile communication storage and currently calculated data is communicated to the vehicle either through a synchronized wired or wireless channel (309). Along with the context information, a request is sent from the mobile communication device (100) to the vehicle for normal communications (310). With the synchronization established and the mobile environmental/geometrical context (311) sent along with the request for mobile communication permission (310) pending, if granted than all communication channels and functions are enabled (315). If the request is denied (312) than a graphic is displayed (313) on the mobile communication device (100) and all communication channels and functions remain disabled (314). The process repeats periodically and is only returned to normal operation when the movement criteria is not achieved or an emergency channel (317) has been initiated. If an emergency channel is established all functions and communications channels are restored (318) until the channel is disconnected and the mobile communication device (100) will revert back to the previous state with the process repeating.

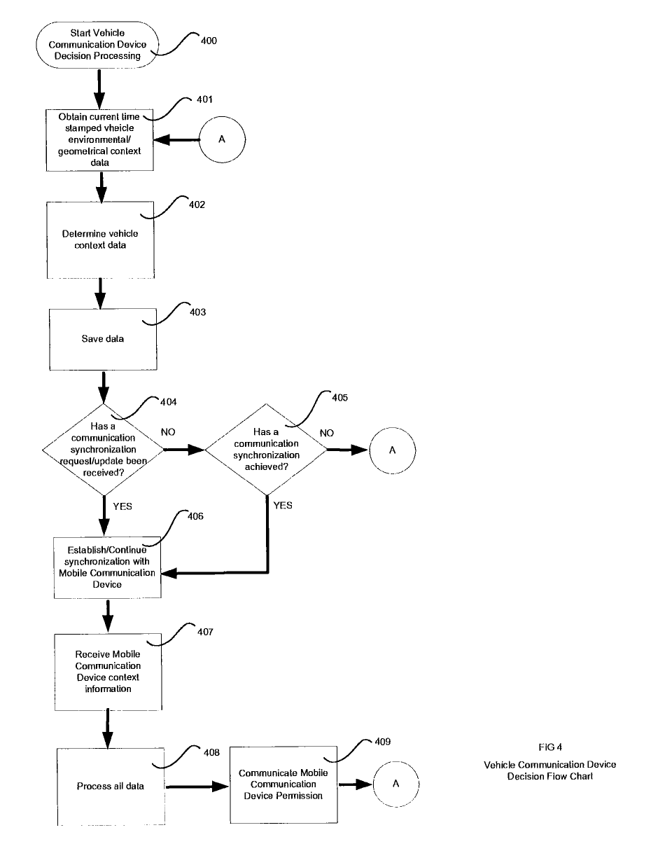

The context algorithms use by the vehicle communication device algorithm processing (202) is illustrative in a process flow diagrams in FIG. 4. As stated above, the vehicle communication device processing routine (400) acquires environmental/geometrical context information (401) from the vehicle communication device' (200) integrated sensors. With the collection of context data, determination of the vehicle context (i.e. velocity and location) is calculated (402) and the data stored (403) for future algorithm processing. This process repeats periodically and no other action is taken unless a synchronization request (404) is received from the mobile communication device (100). If no request is received and no synchronization achieved (405) the process is repeated. Upon a synchronization request from the mobile communication device (100) or if an update is needed the device will establish/continue to keep the channel open (406) to receive mobile communication device context data (407). With both the vehicle and mobile context data known, algorithms are processed (408) to determine a permission state for that mobile communication device (100). The resulting permission state will be transmitted back (409) to the mobile communication device (100) to allow full functionality or if the decision criteria to allow full functionality is not achieved then no permission signal is sent and the mobile communication device (100) remains in its inhibited state. Once the decision is transmitted the process is repeated in a periodic manner.

In at least one embodiment, a location, for example a GPS location, of the mobile communication device (100) is determined, and a location, for example a GPS location, of the vehicle is determined. The location of the mobile communication device (100) is compared to the location of the vehicle. A location of the mobile communication device (100) is triangulated within the vehicle based on the comparison of the location of the mobile communication device (100) to the location of the vehicle. The use of the mobile communication device (100) is controlled based on the location of the mobile communication device (100) within the vehicle. In at least one embodiment, a location of a plurality of mobile devices within the vehicle is determined, and the location of each of the plurality of mobile devices is communicated between each of the plurality of mobile devices to improve an accuracy of the location of each of the plurality of devices. In at least one embodiment on-board diagnostics of the vehicle are received at the mobile communication device (100), and the use of the mobile communication device (100) is controlled based on the on-board diagnostics. For example, the on-board diagnostics may include data related to the vehicle condition, road conditions, or weather conditions. In at least one embodiment, a speed of the vehicle is determined, and the mobile communication device (100) is controlled based on the speed of the vehicle. In at least one embodiment, the use of emergency numbers with the mobile communication device (100) is enabled. In at least one embodiment, the mobile communication device (100) is disabled if the mobile communication device (100) is positioned within a driver's seat of the vehicle. For example, transmitting, receiving and on-going communication channels and functions of the mobile communication device (100) may be disabled. In at least one embodiment, the disabling of the mobile communication device (100) may be overridden to communicate with an emergency number.

What is claimed is:

1. A method of controlling the use of a mobile communication device comprising:
determining a GPS location of the mobile communication device;
determining a GPS location of a vehicle;
comparing the GPS location of the mobile communication device to the GPS location of the vehicle;
triangulating a location of the mobile communication device within the vehicle based on the comparison of the GPS location of the mobile communication device to the GPS location of the vehicle; and
controlling the use of the mobile communication device based on the location of the mobile communication device within the vehicle.

2. The method of claim 1 further comprising:
determining a GPS location of a plurality of mobile devices within the vehicle;
communicating the GPS location of each of the plurality of mobile devices between each of the plurality of mobile devices to improve an accuracy of the GPS location of each of the plurality of devices.

3. The method of claim 1 further comprising:
receiving on-board diagnostics of the vehicle at the mobile communication device; and
controlling the use of the mobile communication device based on the on-board diagnostics.

4. The method of claim 1 further comprising enabling the use of emergency numbers with the mobile communication device.

5. The method of claim 1 further comprising disabling the mobile communication device if the mobile communication device is positioned within a driver's seat of the vehicle.

6. The method of claim 5, wherein disabling the mobile communication device disables transmitting, receiving and on-going communication channels and functions of the mobile communication device.

7. The method of claim 5 further comprising overriding the disabling of the mobile communication device to communicate with an emergency number.

8. The method of claim 1 further comprising:
determining a speed of the vehicle; and
controlling the mobile communication device based on the speed of the vehicle.

9. A method of controlling the use of a mobile communication device comprising:
determining a location of the mobile communication device;
determining a location of a vehicle;
comparing the location of the mobile communication device to the location of the vehicle;
controlling the use of the mobile communication device if the mobile communication device is located within a driver's seat of the vehicle.

10. The method of claim 9 further comprising:
determining a location of a plurality of mobile devices within the vehicle;
communicating the location of each of the plurality of mobile devices between each of the plurality of mobile devices to improve an accuracy of locating of each of the plurality of devices.

11. The method of claim 9 further comprising:
receiving on-board diagnostics of the vehicle at the mobile communication device; and
controlling the use of the mobile communication device based on the on-board diagnostics.

12. The method of claim 9 further comprising enabling the use of emergency numbers with the mobile communication device.

13. The method of claim 9 further comprising disabling the mobile communication device if the mobile communication device is positioned within a driver's seat of the vehicle.

14. The method of claim 13, wherein disabling the mobile communication device disables transmitting, receiving and on-going communication channels and functions of the mobile communication device.

15. The method of claim 13 further comprising overriding the disabling of the mobile communication device to communicate with an emergency number.

16. The method of claim 9 further comprising:
determining a speed of the vehicle; and
controlling the mobile communication device based on the speed of the vehicle.
